(19) United States
(12) Patent Application Publication
(10) Pub. No.: US 2016/0202524 A1
(43) Pub. Date: Jul. 14, 2016

(54) LIQUID CRYSTAL LENS PANEL AND DISPLAY DEVICIE INCLUDING THE SAME

(71) Applicant: SAMSUNG DISPLAY CO., LTD., Yongin-City (KR)

(72) Inventors: Hae-Young Yun, Yongin-City (KR); Jin-Oh Song, Yongin-City (KR); Hyung-Woo Yim, Yongin-City (KR)

(21) Appl. No.: 14/872,481

(22) Filed: Oct. 1, 2015

(30) Foreign Application Priority Data
Jan. 9, 2015 (KR) 10-2015-0003513

(51) Int. Cl. G02F 1/1333; G02F 1/1343; G02B 27/22

(52) U.S. Cl. CPC G02F 1/13338; G02B 27/22; G02F 1/134309; G02F 1/133345

(57) ABSTRACT

A liquid crystal lens panel includes a first substrate including a first electrode disposed on a first base substrate. The liquid crystal lens panel includes a second substrate including a second base substrate including a transmissive area and a non-transmissive area. Sensing patterns are disposed on the second base substrate in the transmissive area. An insulating layer covers the sensing patterns. A second electrode layer is disposed on the insulating layer. A plurality of bus lines is disposed on the second base substrate in the non-transmissive area. The plurality of bus lines is electrically connected to the second electrode layer. A liquid crystal layer is disposed between the first substrate and the second substrate.

### CROSS-REFERENCE TO RELATED APPLICATION

This application claims priority under 35 U.S.C. §119 to Korean Patent Application No. 10-2015-0003513, filed on Jan. 9, 2015, in the Korean Intellectual Property Office, the disclosure of which is incorporated by reference herein in its entirety.

### TECHNICAL FIELD

Exemplary embodiments of the present invention relate to a liquid crystal lens panel, and more particularly to a display device including the liquid crystal lens panel.

### DISCUSSION OF RELATED ART

A display device capable of displaying a 3D image, as well as a planar image, has been developed. The display device may include a display panel for displaying an image, and a liquid crystal lens panel for separating the image displayed on the display panel into a left-eye image and a right-eye image.

When the display device displays a 3D image, the display device may divide a left-eye image and a right-eye image having binocular disparity for a left eye and a right eye of a viewer, respectively, and may provide the viewer with the divided left-eye image and right-eye image. The viewer may view the left-eye image and the right-eye image through the user's left eye and right eye respectively, and the user's brain may combine the images, so that the viewer experiences a 3D effect. When the display device displays a planar image, the display device may provide a viewer with the image without dividing the image into a left-eye image and a right-eye image, so that the viewer views the planar image.

The display device may include a touch screen panel capable of recognizing a touch by a hand of a person or a separate input means. The display device including the touch screen panel may transmit information in response to the recognized touch.

However, when the display device displaying a 3D image includes the touch screen panel and a liquid crystal lens panel, brightness of an image displayed in the display device may be decreased. The reduction in brightness of the image may occur because light emitted from the display panel may be absorbed by the touch screen panel and the liquid crystal panel.

### SUMMARY OF THE INVENTION

Exemplary embodiments of the present invention provide a liquid crystal lens panel having a touch detection function.

Exemplary embodiments of the present invention provide a display device which includes a liquid crystal lens panel having a touch detection function without an optical loss.

An exemplary embodiment of the present invention provides a liquid crystal lens panel including a first substrate including a first electrode disposed on a first base substrate. The liquid crystal lens panel includes a second substrate including a second base substrate including a transmissive area and a non-transmissive area. Sensing patterns are disposed on the second base substrate in the transmissive area. An insulating layer covers the sensing patterns. A second electrode layer is disposed on the insulating layer. A plurality of bus lines is disposed on the second base substrate in the non-transmissive area. The plurality of bus lines is electrically connected to the second electrode layer. A liquid crystal layer is disposed between the first substrate and the second substrate.

The sensing patterns may include a plurality of first sensing cells electrically connected with each other in a first direction inclined with respect to a long side of the second base substrate, and a plurality of second sensing cells electrically connected with each other through the second electrode layer in a second direction crossing the first direction.

The second electrode layer may include a plurality of second electrodes disposed along the second direction. The second sensing cells may be electrically connected to at least one of the second electrodes through a contact hole disposed in the insulating layer.

The second electrode layer may include a plurality of first sub electrodes disposed on the insulating layer along the second direction. An electrode insulating layer may cover the first sub electrodes. A plurality of second sub electrodes may be disposed on the electrode insulating layer. The plurality of second sub electrodes may be disposed along the second direction. The second sensing cells may each be electrically connected to at least one of the first sub electrodes and the second sub electrodes through a contact hole disposed in the insulating layer.

The first sensing cells and the second sensing cells may include metal mesh patterns. The metal mesh pattern may include at least one of Al, Cu, Vr, Ni, and Au. The first sensing cells and the second sensing cells may include transparent conductive layers covering the metal mesh patterns and including a transparent conductive oxide material.

An exemplary embodiment of the present invention provides a display device including a display panel configured to display an image and a liquid crystal lens panel. The liquid crystal lens panel includes a transmissive area and a non-transmissive area. The liquid crystal lens panel includes a plurality of lens parts disposed in the transmissive area, and converts an image of the display panel into one of a 2D image and a 3D image.

The liquid crystal lens panel may include a first substrate including a first base substrate and a first electrode disposed on the first base substrate and a second substrate including a second base substrate facing the first base substrate. Sensing patterns are disposed on the second base substrate in the transmissive area. An insulating layer covers the sensing patterns. A second electrode layer is disposed on the insulating layer. A plurality of bus lines is disposed on the second base substrate in the non-transmissive area. The plurality of bus lines is electrically connected to the second electrode layer. A liquid crystal layer is disposed between the first substrate and the second substrate.

The sensing patterns may include a plurality of first sensing cells electrically connected with each other in a first direction inclined with respect to a long side of the second base substrate, and a plurality of second sensing cells electrically connected with each other through the second electrode layer in a second direction crossing the first direction.

### BRIEF DESCRIPTION OF THE DRAWINGS

The above and other features of the present invention will become more apparent by describing in detail exemplary embodiments thereof with reference to the accompanying drawings, in which:

FIG. 1 is an exploded perspective view illustrating a display device according to an exemplary embodiment of the present invention.

FIG. 2 is a top plan view schematically illustrating the liquid crystal lens panel illustrated in FIG. 1.

FIG. 3 is an enlarged view of region A of FIG. 2.

FIG. 4 is a cross-sectional view taken along line I-I′ of FIG. 3.

FIG. 5 is a cross-sectional view taken along line II-II′ of FIG. 3.

FIGS. 6 and 7 are cross-sectional views of a liquid crystal lens panel of a display device according to an exemplary embodiment of the present invention.

### DETAILED DESCRIPTION OF THE EMBODIMENTS

Hereinafter, exemplary embodiments of the present invention will be described in more detail with reference to the accompanying drawings. Exemplary embodiments of the present invention may be variously modified and may have various forms. However it should be understood that exemplary embodiments of the present invention are not limited to particular exemplary embodiments.

In the accompanying drawings, sizes of structures may be illustrated to be enlarged compared to actual sizes for clarity of illustration. The terms “first”, “second”, and the like may be used for describing various constituent elements, but the constituent elements should not be limited to these terms. Singular expressions used herein may include plurals expressions.

In the specification and drawings dimensions may be exaggerated for clarity of illustration. It will be understood that when an element is referred to as being “between” two elements, it may be the only element between the two elements, or one or more intervening elements may also be present. Like reference numerals may refer to like elements throughout the specification and drawings.

It will be understood that when an element such as a layer, film, region, or substrate is referred to as being “on” another element, it may be directly on the other element or intervening elements may be present. It will be understood that when an element such as a layer, film, region, or substrate is referred to as being “beneath” another element, it may be directly beneath the other element or intervening elements may be present.

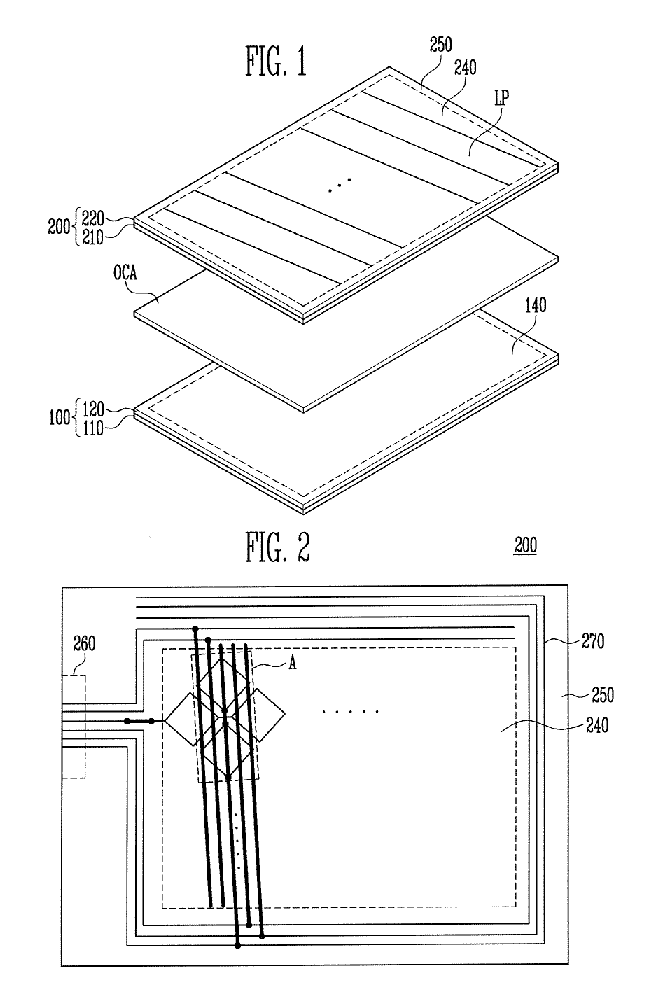

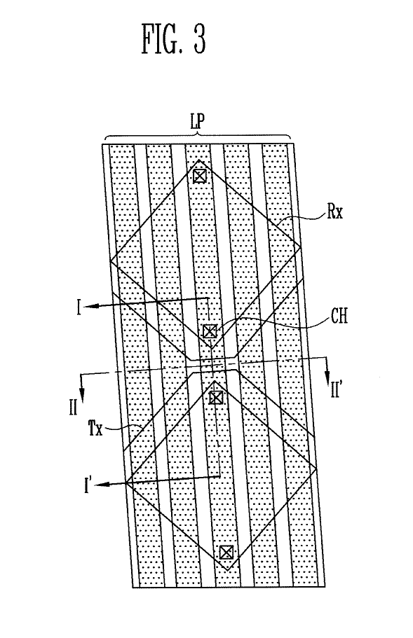

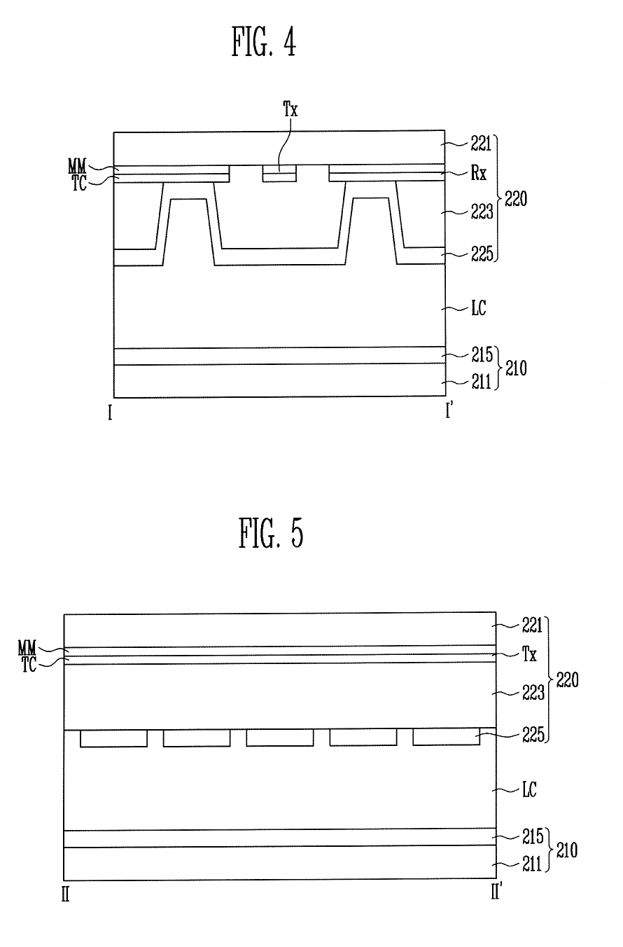

FIG. 1 is an exploded perspective view illustrating a display device according to an exemplary embodiment of the present invention. FIG. 2 is a top plan view schematically illustrating the liquid crystal lens panel illustrated in FIG. 1. FIG. 3 is an enlarged view of region A of FIG. 2. FIG. 4 is a cross-sectional view taken along line I-I′ of FIG. 3. FIG. 5 is a cross-sectional view taken along line II-II′ of FIG. 3.

Referring to FIGS. 1 to 5, a display device may include a display panel 100 and a liquid crystal lens panel 200. The display panel 100 may be coupled to the liquid crystal lens panel 200 by a bonding member. Light may pass through the bonding member. For example, the bonding member may be an optically clear adhesive OCA sheet which may be disposed between the display panel 100 and the liquid crystal lens panel 200. The OCA sheet may include an optically transparent adhesive.

The display panel 100 may display an image. The display panel 100 may include various types of display panels. For example, the display panel 100 may be a self-emitting display panel, such as an Organic Light Emitting Display (OLED) panel or a plasma display panel (PDP). The display panel 100 may be a non-emission display panel, such as a Liquid Crystal Display (LCD) panel, an Electro-Phoretic Display (EPD) panel, or an Electro-Wetting Display (EWD) panel. When the display panel 100 is a non-emission display panel, the display device may include a backlight unit for supplying light to the display panel 100. Exemplary embodiments of the present invention will be described in more detail below based on an exemplary embodiment in which the display panel 100 is the liquid crystal display panel.

The display panel 100 may have a rectangular plate shape including a long side and a short side. The display panel 100 may display an image in a display area 140. The display panel 100 may include an array substrate 110, an opposing substrate 120 facing the array substrate 110, and a first liquid crystal layer disposed between the array substrate 110 and the opposing substrate 120.

According to an exemplary embodiment of the present invention, the array substrate 110 may include a plurality of pixels disposed in a matrix shape. A light blocking layer may be disposed between the pixels. The light blocking layer may reduce or prevent interference from occurring in light passing through each pixel, thereby increasing contrast of the display panel 100. Each pixel may include a gate line disposed along a first direction. The gate line may be disposed along a direction parallel to a corner of the array substrate 110. A data line may be disposed along a second direction crossing the first direction and crossing the gate line. The data line may be insulated from the gate line. Each pixel may include a pixel electrode. Each pixel may include a thin film transistor. The thin film transistor may be electrically connected to the gate line and the data line. The thin film transistor may be electrically connected to the pixel electrode. The thin film transistor may switch a driving signal provided to the corresponding pixel electrode.

Further, a driver IC may be disposed on a side of the array substrate 110. The driver IC may receive signals from the outside, and may output the driving signal driving the display panel 100 to the thin film transistor in response to an input control signal.

The opposing substrate 120 may include at least one RGB color filter for providing predetermined colors by using light emitted from the backlight unit. The opposing substrate 120 may include a common electrode disposed on the RGB color filters. The common electrode may face the pixel electrode. The RGB color filters may be formed by a thin film process. Exemplary embodiments of the present invention may include the common electrode and the RGB color filters disposed on the opposing substrate 120, however, exemplary embodiments of the present invention are not limited thereto. For example, the common electrode and the RGB color filters may be disposed on the array substrate 110.

The first liquid crystal layer may be disposed in a desired direction according to an electric field which may be generated by a voltage applied to the pixel electrode and the common electrode to adjust transmittance of light emitted from the backlight unit to display an image on the display panel 100.

The liquid crystal lens panel 200 may have a shape corresponding to the shape of the display panel 100. The liquid crystal lens panel 200 may have a rectangular plate shape having a short side and a long side according to the display panel 100.

The liquid crystal lens panel 200 may be disposed in a direction in which an image is emitted from the display panel 100. The liquid crystal lens panel 200 may include a transmissive area 240 corresponding to the display area 140 of the display panel 100 and a non-transmissive area 250 at an outer side of the transmissive area 240. The transmissive area 240 may allow the image emitted from the display area 140 to pass through the transmissive area 240.

The liquid crystal lens panel 200 may include a first substrate 210 disposed in the direction in which the image is emitted from the display panel 100 and a second substrate 220 facing the first substrate 210. A second liquid crystal layer LC may be disposed between the first substrate 210 and the second substrate 220.

The first substrate 210 may include a first base substrate 211 and a first electrode 215 disposed on the first base substrate 211.

The first base substrate 211 may include a transparent insulating material that allows light to pass through. The first base substrate 211 may be a rigid type substrate or a flexible type substrate. The rigid type substrate may be a glass substrate, a quartz substrate, a glass ceramic substrate or a crystalline glass substrate. The flexible type substrate may be a film substrate including a polymer organic material or a plastic substrate. The first base substrate 211 may have resistance (e.g., heat resistance) against a high processing temperature during a manufacturing process.

The first electrode 215 may include a transparent conductive oxide material. For example, the first electrode 215 may include an indium tin oxide (ITO) or an indium zinc oxide (IZO).

The second substrate 220 may include a second base substrate 221, sensing patterns disposed on the second base substrate 221 in the transmissive area 240, an insulating layer 223 covering the sensing patterns, a second electrode layer 225 disposed on the insulating layer 223 and a plurality of bus lines 270 disposed on the second base substrate 221 in the non-transmissive area 240.

The second base substrate 221 may face the first base substrate 211. The second base substrate 221 may be the same substrate as the first base substrate 211. That is, the second base substrate 221 may be a rigid type substrate or a flexible type substrate which allows light to pass through.

The sensing patterns may include first sensing cells Tx and second sensing cells Rx. The first sensing cells Tx may be electrically connected with each other in one direction, for example, a first direction. The second sensing cells Rx may be electrically connected with each other in a second direction crossing the first direction. The first direction and the second direction may be inclined with respect to the long side and the short side. Accordingly, the first sensing cells Tx may perform detection in the first direction and the second sensing cells Rx may perform detection in the second direction.

When the first direction and the second direction are parallel to the long side or the short side, edges of the sensing patterns may cross the pixels of the display panel 100, and the moiré effect may be generated. Accordingly, when the first direction and the second direction are inclined with respect to the long side and the short side, a cycle of an area in which the edges of the sensing patterns cross the pixels of the display panel 100 may be relatively large. Accordingly, the occurrence of the moiré effect may be reduced or eliminated, and the display device may provide a viewer with an image with increased clarity.

The first sensing cells Tx and the second sensing cells Rx may be alternately disposed so as not to overlap each other. The first sensing cells Tx and the second sensing cells Rx may include metal mesh patterns MM. The metal mesh patterns MM may include at least one of Al, Cu, Vr, Ni, and Au.

The first sensing cells Tx and the second sensing cells Rx may include the metal mesh patterns MM and transparent conductive layers TC covering the metal mesh patterns MM. The transparent conductive layers TC may include a transparent conductive oxide, for example, an ITO.

The insulating layer 223 may cover the first sensing cells Tx and the second sensing cells Rx. Accordingly, the insulating layer 223 may enable the first sensing cells Tx and the second sensing cells Rx to be insulated from each other. The insulating layer 223 may include contact holes CH for exposing parts of the second sensing cells Rx. The insulating layer 223 may include an organic insulating material.

The second electrode layer may include a plurality of second electrodes 225 disposed along the second direction. The second electrodes 225 may be parallel to each other. The first electrode 215 and the second electrode 225 may form an electric field by an applied voltage. The electric field may arrange liquid crystal molecules within the second liquid crystal layer LC.

At least one of the second electrodes 225 may be connected with the second sensing cells Rx through the contact hole CH. That is, at least one of the second electrodes 225 may serve as a bridge for electrically connecting the second sensing cells Rx.

The second electrodes 225 may include the same material as that of the first electrode 215. For example, the second electrode 225 may include an indium tin oxide (ITO) or an indium zinc oxide (IZO).

The bus lines 270 may reduce or prevent an occurrence of a voltage drop in the second electrodes 225. The bus lines 270 may include the same material as that of the first sensing cells Tx and the second sensing cells Rx. For example, the bus lines 270 may include the same material as that of the metal mesh pattern MM. That is, the bus lines 270 may include at least one of Al, Cu, Vr, Ni, and Au. The bus lines 270 may also include the metal mesh pattern MM and the transparent conductive layer TC covering the metal mesh pattern MM.

The second liquid crystal layer LC may include a plurality of liquid crystal molecules. The plurality of liquid crystal molecules may be initially aligned in a direction horizontal to surfaces of the first substrate 210 and the second substrate 220. According to an exemplary embodiment of the present invention, the initial alignment direction of the liquid crystal molecules is not limited. For example, the liquid crystal molecules may be initially aligned in a direction that is vertical with respect to the surfaces of the first substrate 210 and the second substrate 220.

The liquid crystal lens panel 200 may convert an image of the display panel 100 into a 2D image or a 3D image. The liquid crystal lens panel 200 may be disposed in a direction in which an image is emitted from the display panel 100.

A plurality of lens parts LP may be disposed in the transmissive area 240. The lens parts LP may divide an image formed in the display panel 100 into a left-eye image and a right-eye image.

A plurality of second electrodes 225 may be disposed in each lens part LP. For example, five second electrodes 225 may be disposed in each lens part LP. That is, the first electrode 215, the second liquid crystal layer LC, and the five second electrodes 225 may be included in one lens part LP. Since the second electrodes 225 may have a shape extended in the second direction which is inclined with respect to the long side and the short side of the liquid crystal lens panel 200, the lens parts LP may have a shape extended in the second direction. Since the lens parts LP may be extended in the second direction, boundaries of the lens parts LP may cross the pixels of the display panel 100, thereby reducing or eliminating the occurrence of the moiré effect. Accordingly, the display device may provide a viewer with an image with increased clarity.

According to an exemplary embodiment of the present invention five second electrodes 225 may be disposed in the lens part LP, but exemplary embodiments of the present invention are not limited thereto. The number of second electrodes 225 disposed in the lens part LP may be determined according to whether the lens parts LP may form the liquid crystal lens by applying the electric field.

The number of bus lines 270 may be the same as the number of second electrodes 225 disposed in the lens parts LP. According to an exemplary embodiment of the present invention, the five second electrodes 225 may be disposed in the lens part LP, and the lens part LP may include five bus lines 270. The bus lines 270 may be extended from a pad part 260 disposed at one side of the non-transmissive area 240.

In the liquid crystal lens panel 200, when power is not applied to the first electrode 215 and the second sub electrodes 225, the liquid crystal molecules of the second liquid crystal layer LC may maintain an initial alignment state. For example, the liquid crystal molecules may be in a horizontally arranged state.

When a first voltage is supplied to the first electrode 215, and a second voltage is supplied to the first sub electrodes 225, an electric field may be formed between the first electrode 215 and the second electrode 225. The liquid crystal molecules may be driven by the electric field.

A size of a liquid crystal driving voltage driving the liquid crystal molecules may be a difference between the first voltage and the second voltage. The liquid crystal molecules may be driven so as to have a predetermined angle in a horizontal direction with respect to the horizontal direction to the surfaces of the first substrate 210 and the second substrate 220 in proportional to a size of the liquid crystal driving voltage. At a predetermined voltage, the liquid crystal molecules might not be driven. Here, a voltage at which the liquid crystal molecules are not driven may be a threshold voltage. The liquid crystal driving voltage may be set to be larger or equal to the threshold voltage. When the liquid crystal driving voltage is equal to or larger than the threshold voltage, the liquid crystal molecules may be driven in the direction vertical to the surfaces of the first substrate 210 and the second substrate 220.

When the display panel 100 displays a 3D image, the liquid crystal lens panel 200 may divide the image formed in the display panel 100 into a left-eye image and a right-eye image. The liquid crystal lens panel 200 may enable the lens part LP to be driven as a Fresnel lens by differentiating the second voltage supplied to the second electrodes 225.

The display device may include the liquid crystal lens panel 200 having a touch detection function in the direction in which the image is emitted from the display panel 100. That is, the display device might not separately include the touch screen panel and the liquid crystal lens panel 200. Accordingly, the display device may have relatively low brightness degradation of the image emitted from the display panel 100. That is, a viewer may view an image with increased brightness.

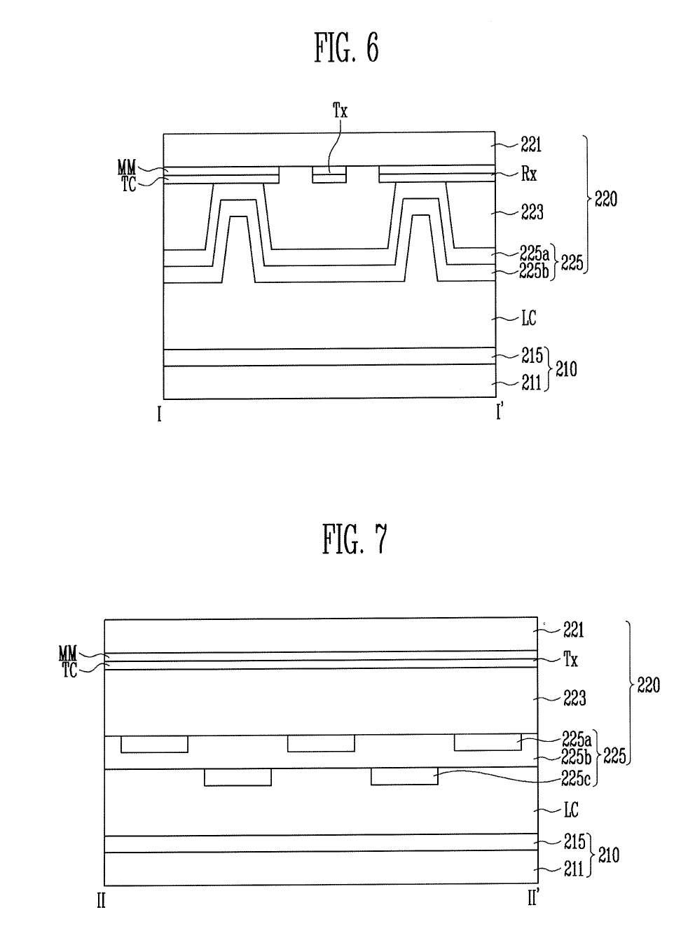

FIGS. 6 and 7 are cross-sectional views of a liquid crystal lens panel of a display device according to an exemplary embodiment of the present invention.

Referring to FIGS. 1 to 3, and FIGS. 6 and 7, the liquid crystal lens panel 200 may include the first substrate 210, the second substrate 220 facing the first substrate 210, and the second liquid crystal layer LC disposed between the first substrate 210 and the second substrate 220.

The first substrate 210 may include the first base substrate 211 and the first electrode 215 disposed on the first base substrate 211.

The second substrate 220 may include the second base substrate 221, sensing patterns disposed on the second base substrate 221 in the transmissive area 240, the insulating layer 223 covering the sensing patterns, a second electrode layer 225 disposed on the insulating layer 223 and extended in one direction, and the plurality of bus lines 270 disposed on the second base substrate 221 in the non-transmissive area 240.

The second base substrate 221 may be a rigid type substrate or a flexible type substrate which allows light to pass through.

The sensing patterns may include the first sensing cells Tx and the second sensing cells Rx. The first sensing cells Tx and the second sensing cells Rx may include the metal mesh patterns MM. The first sensing cells Tx and the second sensing cells Rx may include the metal mesh patterns MM and transparent conductive layers TC covering the metal mesh patterns MM.

The second electrode layer 225 may include a plurality of first sub electrodes 225a disposed on the insulating layer 223, an electrode insulating layer 225b covering the first sub electrodes 225a, and a plurality of second sub electrodes 225c disposed on the electrode insulating layer 225b.

The first sub electrodes 225a and the second sub electrodes 225c may be parallel to each other, and may be alternately disposed without overlapping each other. The first sub electrodes 225a and the second sub electrodes 225c may be extended in a second direction inclined with respect to a long side and a short side of the liquid crystal lens panel 200.

At least one of the first sub electrodes 225a and the second sub electrodes 225c may be connected with the second sensing cells Rx through the contact hole CH. That is, at least one of the first sub electrodes 225a and the second sub electrodes 225c may serve as a bridge electrically connecting the second sensing cells Rx.

The first sub electrodes 225a and the second sub electrodes 225c may be connected to the bus lines 270 disposed in the non-transmissive area 250. Accordingly, an occurrence of a voltage drop in the first sub electrodes 225a and/or the second sub electrodes 225c may be reduced or prevented.

A plurality of lens parts LP may be disposed in the transmissive area 240 of the liquid crystal lens panel 200. The lens parts LP may divide an image formed in the display panel 100 into a left-eye image and a right-eye image.

The plurality of first sub electrodes 225a and the plurality of second sub electrodes 225c may be disposed in the lens parts LP. For example, three first sub electrodes 225a and two second sub electrodes 225c may be disposed in the lens part LP. That is, three first sub electrodes 225a and two second sub electrodes 225c may be included in one lens part LP.

According to an exemplary embodiment of the present invention three first sub electrodes 225a and two second sub electrodes 225c may be disposed in the lens part LP, but exemplary embodiments of the present invention are not limited thereto. The number of first sub electrodes 225 and the number of second sub electrodes 225c disposed in the lens part LP may be determined according to whether the lens parts LP may form the liquid crystal lens by applying the electric field.

The number of bus lines 270 may be the same as a sum of the number of the first sub electrodes 225a and the number of second sub electrodes 225c disposed in the lens part LP. According to an exemplary embodiment of the present invention, three first sub electrodes 225a and two second sub electrodes 225c may be disposed in the lens part LP. The lens part LP may include five bus lines 270.

In the liquid crystal lens panel 200, when power is not applied to the first electrode 215, the first sub electrodes 225a, and the second sub electrodes 225c, the liquid crystal molecules of the second liquid crystal layer LC may maintain an initial alignment state. For example, the liquid crystal molecules may be in a horizontally arranged state.

When a first voltage is supplied to the first electrode 215, and a second voltage is supplied to the first sub electrodes 225a and the second sub electrodes 225c, an electric field may be formed between the first electrode 215 and the second electrode 225. The liquid crystal molecules may be driven by the electric field.

A size of a liquid crystal driving voltage driving the liquid crystal molecules may be a difference between the first voltage and the second voltage. The liquid crystal driving voltage may be set to be larger or equal to the threshold voltage. When the liquid crystal driving voltage is equal to or larger than the threshold voltage, the liquid crystal molecules may be driven in the direction that is vertical with respect to the surfaces of the first substrate 210 and the second substrate 220.

A level of the second voltage applied to the second sub electrodes 225c may be decreased by an electrode insulating layer 225b disposed on the first sub electrodes 225a. The reason is that a voltage may be reduced by an intrinsic resistance value of the electrode insulating layer itself. Accordingly, a voltage difference value between the second sub electrodes 225c and the first electrode 215 may be smaller than a voltage difference value between the first voltage and the second voltage by the intrinsic resistance of the electrode insulating layer 225b formed on the first sub electrodes 225a. In this case, the voltage difference between the first sub electrodes 225a and the first electrode 215 may be different from the voltage difference between the second sub electrodes 225c and the first electrode 215. A liquid crystal driving voltage between the first sub electrodes 225a and the first electrode 215 may be different from a liquid crystal driving voltage between the second sub electrodes 225c and the first electrode 215.

An intensity of the electric field may be proportional to a level of the voltage, so that intensities of the electric fields between the first sub electrodes 225a and the first electrode 215, and the second sub electrodes 225c and the first electrode 215 may be different from each other. Accordingly, a difference between the liquid crystal driving voltage between the first sub electrodes 225a and the first electrode 215 and the liquid crystal driving voltage between the second sub electrodes 225c and the first electrode 215 may be decreased. When a difference between upper surfaces of the first sub electrodes 225a and an upper surface of the electrode insulating layer 225b is equal to or smaller than about 2,000 Å, a voltage drop of about 0.1 V or lower may be generated. Accordingly, when a difference between the liquid crystal driving voltage between the first sub electrodes 225a and the first electrode 215 and the liquid crystal driving voltage between the second sub electrodes 225c and the first electrode 215 is 0.1 V or lower, the liquid crystal molecules may be driven in a vertical direction.

When the display panel 100 displays a 3D image, the liquid crystal lens panel 200 may divide the image formed in the display panel 100 into a left-eye image and a right-eye image. The liquid crystal lens panel 200 may allow the lens part LP to form a Fresnel lens by differentiating the second voltage applied to each of the first sub electrodes 225a and the second sub electrodes 225c.

The liquid crystal lens panel may have the touch detection function. Accordingly, a display device including the liquid crystal lens panel may have a relatively small optical loss, thereby providing a viewer with an image with increased brightness.

While the invention has been particularly shown and described with reference to exemplary embodiments thereof, it will be understood by those of ordinary skill in the art that various changes in form and detail may be made therein without departing from the spirit and scope of the present invention.

What is claimed is:

1. A liquid crystal lens panel, comprising:
a first substrate including a first electrode disposed on a first base substrate;
a second substrate including a second base substrate comprising a transmissive area and a non-transmissive area, sensing patterns disposed on the second base substrate in the transmissive area, an insulating layer covering the sensing patterns, a second electrode layer disposed on the insulating layer, and a plurality of bus lines disposed on the second base substrate in the non-transmissive area, wherein the plurality of bus lines are electrically connected to the second electrode layer; and
a liquid crystal layer disposed between the first substrate and the second substrate,
wherein the sensing patterns include a plurality of first sensing cells electrically connected with each other in a first direction inclined with respect to a long side of the second base substrate, and a plurality of second sensing cells electrically connected with each other through the second electrode layer in a second direction, and wherein the second direction crosses the first direction.

2. The liquid crystal lens panel of claim 1, wherein the second electrode layer includes a plurality of second electrodes disposed along the second direction.

3. The liquid crystal lens panel of claim 2, wherein the second sensing cells are electrically connected to at least one of the second electrodes through a contact hole disposed in the insulating layer.

4. The liquid crystal lens panel of claim 1, wherein the second electrode layer includes:
a plurality of first sub electrodes disposed on the insulating layer, wherein the plurality of first sub electrodes is disposed along the second direction;
an electrode insulating layer covering the first sub electrodes; and
a plurality of second sub electrodes disposed on the electrode insulating layer, wherein the plurality of second sub electrodes is disposed along the second direction.

5. The liquid crystal lens panel of claim 4, wherein the second sensing cells are each electrically connected to at least one of the first sub electrodes and the second sub electrodes through a contact hole disposed in the insulating layer.

6. The liquid crystal lens panel of claim 1, wherein the first sensing cells and the second sensing cells include metal mesh patterns.

7. The liquid crystal lens panel of claim 6, wherein the metal mesh pattern includes at least one of Al, Cu, Vr, Ni, and Au.

8. The liquid crystal lens panel of claim 7, wherein the first sensing cells and the second sensing cells further include transparent conductive layers covering the metal mesh patterns and including a transparent conductive oxide material.

9. A display device, comprising:
a display panel configured to display an image; and
a liquid crystal lens panel comprising a transmissive area and a non-transmissive area, wherein the liquid crystal lens panel includes a plurality of lens parts disposed in the transmissive area, and wherein the liquid crystal lens panel is configured to convert the image of the display panel into one of a 2D image and a 3D image,
wherein the liquid crystal lens panel includes:
a first substrate including a first base substrate and a first electrode disposed on the first base substrate;
a second substrate including a second base substrate facing the first base substrate, sensing patterns disposed on the second base substrate in the transmissive area, an insulating layer covering the sensing patterns, a second electrode layer disposed on the insulating layer, and a plurality of bus lines disposed on the second base substrate in the non-transmissive area, wherein the plurality of bus lines are electrically connected with the second electrode layer; and
a liquid crystal layer disposed between the first substrate and the second substrate,
wherein the sensing patterns include a plurality of first sensing cells electrically connected with each other in a first direction inclined with respect to a long side of the second base substrate, and a plurality of second sensing cells electrically connected with each other through the second electrode layer in a second direction, and wherein the second direction crosses the first direction.

10. The display device of claim 9, wherein the second electrode layer includes a plurality of second electrodes disposed along the second direction.

11. The display device of claim 10, wherein the second sensing cells are electrically connected to at least one of the second electrodes through a contact hole disposed in the insulating layer.

12. The display device of claim 10, wherein a plurality of second electrodes is disposed in each lens part.

13. The display device of claim 12, wherein the number of bus lines is the same as the number of second electrodes disposed in the lens part.

14. The display device of claim 9, wherein the second electrode layer Includes:
a plurality of first sub electrodes disposed on the insulating layer, wherein the plurality of first sub electrodes extends along the second direction;
an electrode insulating layer covering the first sub electrodes; and
a plurality of second sub electrodes disposed on the electrode insulating layer, wherein the plurality of second sub electrodes is disposed along the second direction.

15. The display device of claim 14, wherein the second sensing cells are each electrically connected to at least one of the first sub electrodes and the second sub electrodes through a contact hole disposed in the insulating layer.

16. The display device of claim 14, wherein the plurality of first sub electrodes and the plurality of second sub electrodes are disposed in each lens part.

17. The display device of claim 16, wherein the number of bus lines is the same as a sum of the number of first sub electrodes and the number of second sub electrodes.

18. The display device of claim 9, wherein the first sensing cells and the second sensing cells each include metal mesh patterns.

19. The display device of claim 18, wherein the metal mesh pattern includes at least one of Al, Cu, Vr, Ni, or Au.

20. The display device of claim 19, wherein the first sensing cells and the second sensing cells further include transparent conductive layers covering the metal mesh patterns, wherein the transparent conductive layers each include a transparent conductive oxide material.
